(19) United States
(12) Patent Application Publication
(10) Pub. No.: US 2018/0276865 A1
(43) Pub. Date: Sep. 27, 2018

(54) DATA VISUALIZATION METHOD FOR GRAPHICALLY REPRESENTING DATA FROM FOUR OR MORE VARIABLES IN A TWO-DIMENSIONAL (2D) HEATMAP

(71) Applicants: Michael W Pinch, Scottsville, NY (US); David Yeaple, Canandaigua, NY (US)

(72) Inventors: Michael W Pinch, Scottsville, NY (US); David Yeaple, Canandaigua, NY (US)

(73) Assignee: SNAPEVAL, LLC, Scottsville, NY (US)

(21) Appl. No.: 15/928,674

(22) Filed: Mar. 22, 2018

Related U.S. Application Data
(60) Provisional application No. 62/476,942, filed on Mar. 27, 2017.

(51) Int. Cl. G06T 11/60; G06T 11/00; G06T 11/20

(52) U.S. Cl. CPC G06T 11/60; G06T 11/206; G06T 11/001

(57) ABSTRACT

As disclosed, a method for adding an overlay to each cell of a two-dimensional (2D) heatmap to graphically represent the data for each additional variable, in excess of the three variables [X, Y, Z] rendered in the 2D heatmap.

This application claims the benefit of U.S. Provisional Application No. 62/476,942, entitled “Data Visualization Method for Graphically Representing Data from Four or More Variables in a Two-Dimensional (2D) Heatmap,” filed Mar. 27, 2017, which is hereby incorporated by reference.

### REFERENCES CITED

U.S. Patent Awards

| | | |
|---|---|---|
| US9761025B2 | Data visualization methods | Cardno, et al. |
| US9454832B2 | Data visualization methods | Cardno, et al. |
| US7986323B2 | Two dimensional user interface for | Kobayashi, et al. |
| | multidimensional data analysis | |
| US9355482B2 | Dimension reducing visual representation method | Cardno, et al. |
| US9058695B2 | Method of graphically representing a tree structure | Cardno, et al. |

U.S. Patent Applications

| | | |
|---|---|---|
| US20040027350A1 | Methods and system for simultaneous visualization | Kincaid, et al. |
| | and manipulation of multiple data types | |
| US20150310645A1 | Displaying Information Technology Conditions with | Baumecker, et al. |
| | Heat Maps | |
| US20160267693A1 | Dimension reducing visual representation method | Cardno, et al. |

### TECHNICAL FIELD

The present disclosure is directed to a method for adding an overlay to each cell of a two-dimensional (2D) heatmap to graphically represent the data for each additional variable, in excess of the three variables [X, Y, Z] rendered in the 2D heatmap.

### BACKGROUND

A heatmap is a graphical representation of data where the individual values contained in a matrix are represented as colors.¹ ¹Term “heatmap” was first recognized for use in the graphical display of financial market information. United States Patent and Trademark Office, registration #75263259″. 1993 Sep. 1.

Two-dimensional (2D) heatmaps represent a matrix of three variables [X, Y, Z] as a spectrum of colored or shaded squares or rectangles (cells) displayed in a row and column format. Values X and Y determine the respective locations on the x-axis and y-axis where the value Z is represented by the shading or color of the cell at that location according to a scale. Optionally, the numerical value for value Z can also be displayed in each shaded or colored cell.

One of the most important design characteristics of 2D heatmaps is that they can be printed and viewed on a flat sheet of paper, or viewed statically on a two-dimensional computing display, without obscuring any data in the chart for the X, Y, or Z values.

2D heatmaps are not designed to graphically represent matrices with four or more variables. To use heatmaps to render more than three variables, an additional axis must be added to the heatmap for each variable in excess of three variables. For example, a matrix of four variables requires a heatmap with three axes and is a three-dimensional (3D) heatmap.

Heatmaps with three axes or more axes are complex to visualize when printed and viewed on a flat sheet of paper, or viewed statically on a two-dimensional computing display. In addition, when heatmaps with three or more axes are printed and viewed on a flat sheet of paper, or viewed statically on a two-dimensional computing display, data for values rendered “toward the front” often obscures data for values rendered “toward the back” of these heatmaps.

### Advantages

The use of two-dimensional (2D) heatmaps to represent a matrix of three variables [X, Y, Z] as a spectrum of colored or shaded squares or rectangles (cells) displayed in a row and column format is known. Values X and Y determine the respective locations on the x-axis and y-axis where the value Z is represented by the shading or color of the cell at that location according to a scale. Optionally, the numerical value for value Z can also be displayed in each shaded or colored cell.

The use of overlays to superimpose data or graphics on maps or charts is known. Overlaying graphical icons to signify status or condition is known.

An advantage exists for a method that enables data for four or more variables to be rendered in a heatmap without requiring that the heatmap have three or more axes.

A further advantage exists for a method that enables data for four or more variables to be rendered in a heatmap without requiring that the heatmap have three or more axes, so that the heatmap can be printed and viewed on a flat sheet of paper, or displayed statically on a two-dimensional computer display, without obscuring any of the data from any of the variables.

### BRIEF SUMMARY

The present disclosure is directed to a method for applying a graphical overlay to each cell of a two-dimensional (2D) heatmap to graphically represent the data for each additional variable in excess of the data for the three variables [X, Y, Z] rendered in the 2D heatmap.

In one aspect, the graphical overlay for each cell includes one unique region or one unique graphical icon for each variable in excess of the three variables [X, Y, Z] rendered in the 2D heatmap.

In another aspect, a unique region can be in any location within a cell, including the cell's border or the fill area of the alphanumerical value for the Z value in the cell.

In another aspect, the unique graphical icon or unique region for each variable is always in the same location in each cell.

In another aspect, the fill [color or shade] of the unique region or unique graphical icon is varied according to a scale specific to the variable, so that it represents the value for the variable in the cell, based on the cell's X and Y coordinates.

In yet another aspect, the value of a variable may also be displayed alphanumerically in the unique region or unique graphical icon in each cell.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

As the color drawings are being filed electronically via EFS-Web, only one set of the drawings is submitted.

Credit card payment has been submitted for the requisite fee for this Petition.

The invention of the present disclosure will become more fully understood from the detailed description and the accompanying drawings, wherein:

FIG. 1 illustrates a prior art 2D heatmap.

FIG. 2 illustrates a prior art 2D heatmap that includes numerical value of the Z variable displayed in each cell.

FIG. 3 illustrates a 2D heatmap with the addition of an overlay graphical icon surrounding the Z variable numerical value in each cell.

FIG. 4 illustrates a 2D heatmap with the addition of an overlay fill color to the Z variable numerical value in each cell.

FIG. 5 illustrates a 2D heatmap with the addition of an overlay border color around each cell.

FIG. 6 illustrates a 2D heatmap with the addition of two overlay graphical icons in each cell.

FIG. 7 illustrates a 2D heatmap with the addition of two overlay graphical icons, each with a numerical value, in each cell.

FIG. 8 illustrates a 2D heatmap with the addition of two overlay regions in each cell.

FIG. 9 illustrates a 2D heatmap with the addition of two overlay regions, each with a numerical value, in each cell.

FIG. 10 illustrates a prior art 3D heatmap.

FIG. 11 illustrates a prior art 3D heatmap.

FIG. 12 illustrates a prior art 3D heatmap.

FIG. 13 illustrates a prior art 4D heatmap.

FIG. 14 illustrates a prior art bubble heatmap.

### DETAILED DESCRIPTION

The following description of the embodiments is merely exemplary in nature and is in no way intended to limit the invention. The description of illustrative embodiments is intended to be read in connection with the accompanying drawings, which are to be considered part of the entire written description. The discussion herein describes and illustrates some possible non-limiting combinations of features that may exist alone or in other combinations of features.

Two-dimensional (2D) heatmaps represent a matrix of three variables [X, Y, Z] as a spectrum of colored or shaded squares or rectangles (cells) displayed in a row and column format. Values X and Y determine the respective locations on the x-axis and y-axis where the value Z is represented by the shading or color of the cell at that location according to a scale. Optionally, the numerical value for value Z can also be displayed in each shaded or colored cell.

For illustration, the matrix of three variable data could be “Organizational Goal Area” [X], “Employee Name” [Y], and “Number of Times the Employee has received Feedback in the Goal Area” [Z]. Sample data for these variables is shown in Table 1.

TABLE 1

| | | Number of Times the Employee |
|---|---|---|
| Organizational | Employee Name | has Received Feedback in the |
| Goal Area [X] | [Y] | Goal Area [2] |
| Teamwork | Sally Jones | 2 |
| Teamwork | Betty Goodman | 0 |
| Teamwork | John Adams | 3 |
| Communications | Sally Jones | 1 |
| Communications | Betty Goodman | 4 |
| Communications | John Adams | 2 |
| Quality | Sally Jones | 5 |
| Quality | Betty Goodman | 7 |
| Quality | John Adams | 6 |

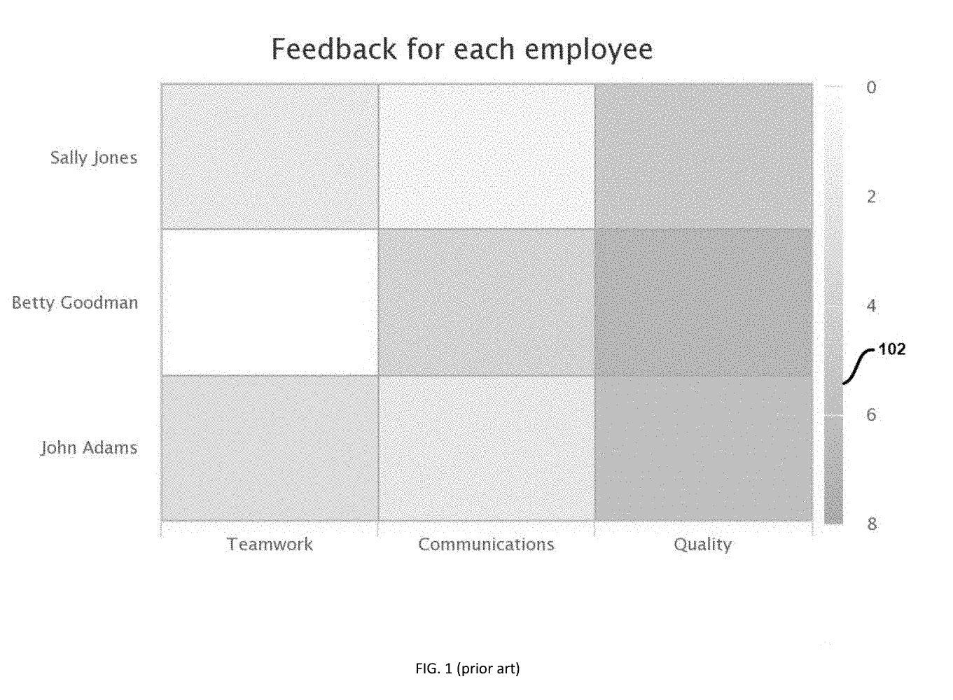

FIG. 1 illustrates a prior art 2D heatmap displaying three variables: “Organizational Goal Area” [X], “Employee Name” [Y], and “Number of Times the Employee has received Feedback in the Goal Area” [Z]. The values for variables X, Y and Z are from Table 1. The scale on the right hand side of the heatmap 102 corresponds to the range of Z values displayed in the cells of the heatmap. Darker shading in the scale indicates higher Z values. This 2D heatmap was generated with a commercial graphics package.

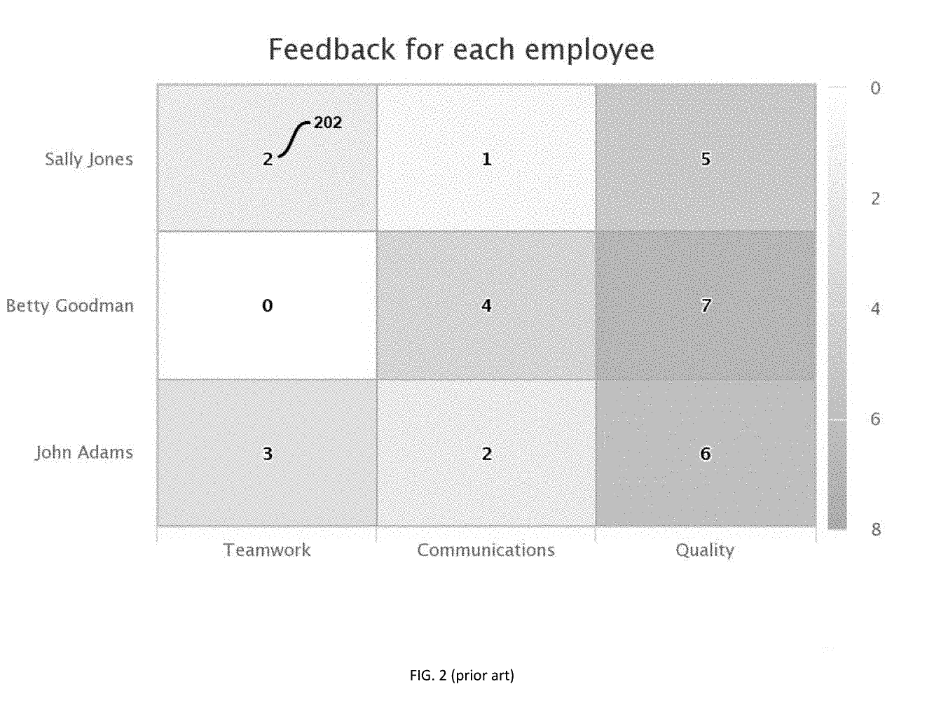

FIG. 2 illustrates a prior art 2D heatmap displaying the identical sample data from Table 1, except that the numerical values of for the Z variable are also displayed in each cell 202. The displayed values in each cell make it easier for the chart viewer to distinguish between Z values that are close to one another, such as the difference between a ‘2’ and a ‘3.’ This 2D heatmap was generated with a commercial graphics package.

To display data for additional variables [e.g. A, B, C, etc.], the invented method is to apply a graphical overlay to each cell of a two-dimensional (2D) heatmap to graphically represent the data for each additional variable in excess of the data for the three variables [X, Y, Z] rendered in the 2D heatmap.

The graphical overlay for each cell includes one unique region or one unique graphical icon for each variable in excess of the three variables [X, Y, Z] rendered in the 2D heatmap.

A unique region can be in any location within a cell, including the cell's border or the fill area of the alphanumerical value for the Z value in the cell.

The unique graphical icon or unique region for each variable is always in the same location in each cell.

The fill [color or shade] of the unique region or unique graphical icon is varied according to a scale specific to the variable, so that it represents the value for the variable in the cell, based on the cell's X and Y coordinates.

The value of a variable may also be displayed alphanumerically in the unique region or unique graphical icon in each cell.

For illustration of overlaying one variable on a 2D heatmap, an additional variable of “Average Achievement Level of the Feedback Received” [A] has been added to the sample data as shown in Table 2.

TABLE 2

| | | Number of Times | Average |
|---|---|---|---|
| | | the Employee | Achievement |
| | | Has received | Level |
| | Employee | Feedback in | of the Feedback |
| Organizational | Name | the Goal | Received |
| Goal Area [X] | [Y] | Area [Z] | [A] |
| Teamwork | Sally Jones | 2 | 4.00 |
| Teamwork | Betty | 0 | N/A |
| | Goodman | | |
| Teamwork | John Adams | 3 | 2.75 |
| Communications | Sally Jones | 1 | 2.25 |
| Communications | Betty | 4 | 2.00 |
| | Goodman | | |
| Communications | John Adams | 2 | 3.75 |
| Quality | Sally Jones | 5 | 0.50 |
| Quality | Betty | 7 | 1.50 |
| | Goodman | | |
| Quality | John Adams | 6 | 1.75 |

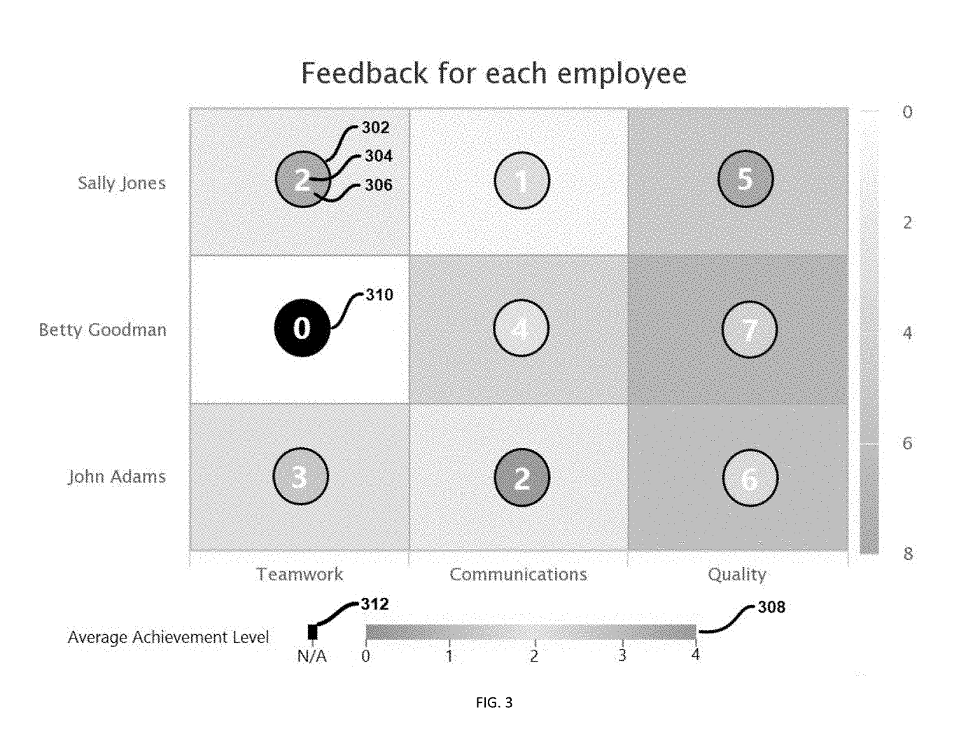

FIG. 3 illustrates the same 2D heatmap displayed in FIG. 2 with the addition of a graphical overlay with a graphical icon surrounding the numerical value in each cell 302. The numerical value in each cell 304 still displays the value of the Z variable in that cell (in this example, the “Number of Times the Employee has received Feedback in the Goal Area” [Z]). In accordance with the method disclosed herein, the color of the fill area in the overlay graphical icon surrounding the numerical value 306 corresponds to the “Average Achievement Level of the Feedback Received” [A] variable from Table 2 for that cell. The scale below the graph 308 displays the range of colors associated with values for variable A. In this example, note that black is displayed as the fill color in the overlay graphical icon 310 when no value is applicable for value A in accordance with the N/A value on the scale 312 for this variable.

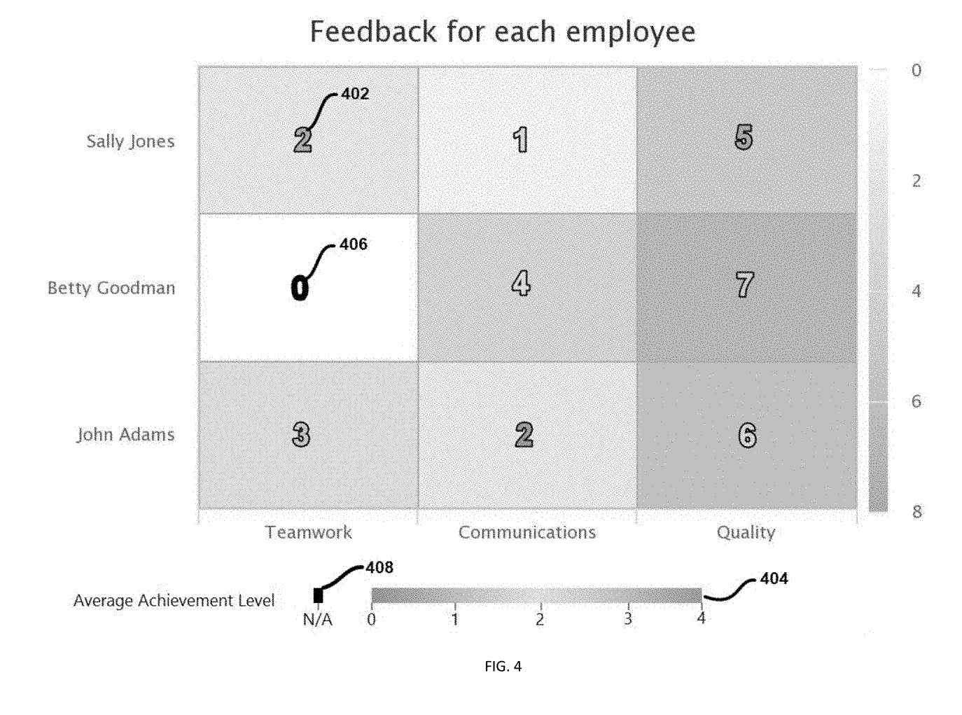

FIG. 4 illustrates the same information displayed in the 2D heatmap in FIG. 3. In this application of the method disclosed herein, the color of the fill 402 of the numerical value for variable Z corresponds to the “Average Achievement Level of the Feedback Received” [A] variable from Table 2 for that cell. The scale below the graph 404 displays the range of colors associated with values for variable A. In this example, note that black is displayed as the fill color in the numeric value 406 when no value is applicable for value A in accordance with the N/A value on the scale 408 for this variable.

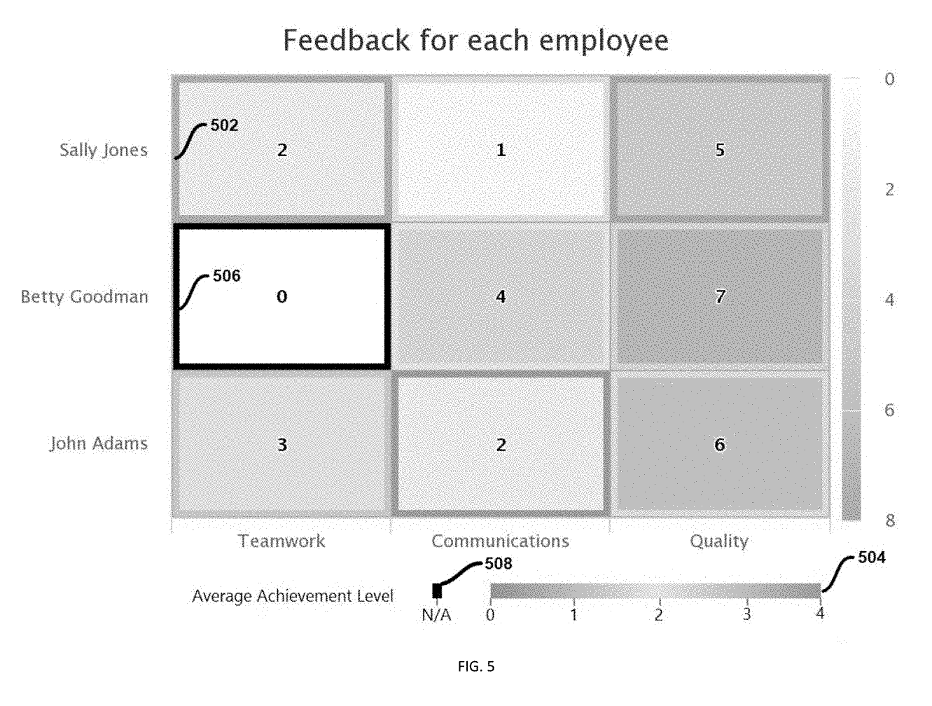

FIG. 5 illustrates the same information displayed in the 2D heatmap in FIG. 3. In this application of the method disclosed herein, the color of the outline of each cell 502 corresponds to the “Average Achievement Level of the Feedback Received” [A] variable from Table 2 for that cell. The scale below the graph 504 displays the range of colors associated with values for variable A. In this example, note that black is displayed as the fill color in the outline 506 when no value is applicable for value A in accordance with the N/A value on the scale 508 for this variable.

For illustration of overlaying data for multiple variables on a 2D heatmap in accordance with the invented method, the additional variables of “Average Local Temperature when the Feedback was Created” [B], and “Average Local Time when the Feedback was Created” [C] have been added to the sample data as shown in Table 3.

TABLE 3

| | | Number of Times | | | |
|---|---|---|---|---|---|
| | | the Employee | Average | Average Local | |
| | | Has received | Achievement | Temperature | Average Local |
| | | Feedback in | Level of the | when the | Time when the |
| Organizational | Employee | the Goal | Feedback | Feedback was | Feedback was |
| Goal Area [X] | Name [Y] | Area [Z] | Received [A] | Created [B] | Created [C] |
| Teamwork | Sally Jones | 2 | 4.00 | 22.5 | 16:19 |
| Teamwork | Betty | 0 | N/A | N/A | N/A |
| | Goodman | | | | |
| Teamwork | John Adams | 3 | 2.75 | 28.8 | 11:20 |
| Communications | Sally Jones | 1 | 2.25 | 18.9 | 10:32 |
| Communications | Betty | 4 | 2.00 | 25.0 | 10:04 |
| | Goodman | | | | |
| Communications | John Adams | 2 | 3.75 | 26.7 | 8:55 |
| Quality | Sally Jones | 5 | 0.50 | 21.3 | 13:54 |
| Quality | Betty | 7 | 1.50 | 26.3 | 11:51 |
| | Goodman | | | | |
| Quality | John Adams | 6 | 1.75 | 24.6 | 14:10 |

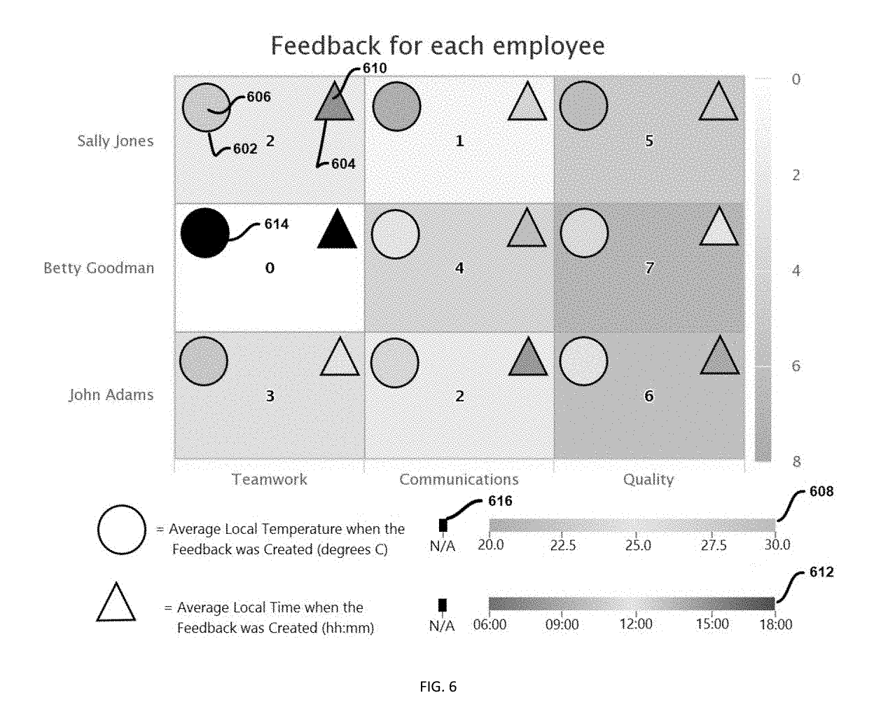

FIG. 6 illustrates adding two additional variables to the 2D heatmap in FIG. 2. In this application of the method disclosed herein, the values in each cell for the variables “Average Local Temperature when the Feedback was Created” [B], and “Average Local Time when the Feedback was Created” [C] are from Table 3. Two unique graphical icons have been overlaid on this 2D heatmap. As examples, a graphical icon in the shape of a circle 602 for the variable B and a graphical icon in the shape of a triangle 604 for variable C are used.

In accordance with the method disclosed herein, the fill color of the graphical circle icon in the upper left hand corner of each cell 606 has been varied according to value for variable B for that cell, as governed by the color scale 608 for values of variable B. The fill color of the graphical triangle icon in the upper right hand corner of each cell 610 has been varied according to value for variable C for that cell, as governed by the color scale 612 for values of variable C. In this example, black is displayed as the fill color for a graphical icon 614 when no value is applicable for a variable in accordance with the N/A value on the scale 616 for this variable.

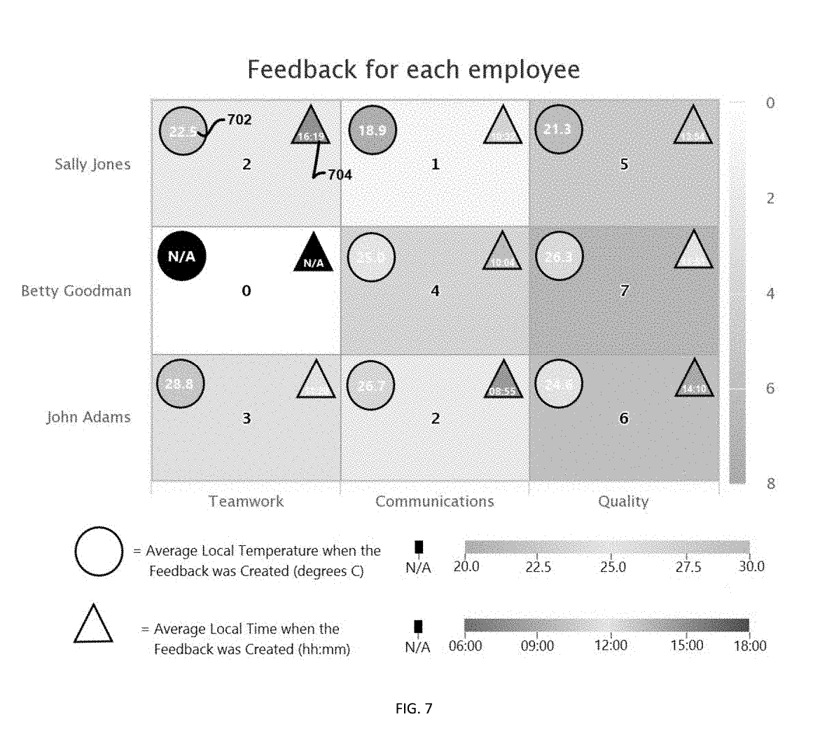

FIG. 7 illustrates the same information and overlay graphical icons for variables B and C for the 2D heatmap as in shown FIG. 6, with the addition of numerical values displayed in each graphical icon for variables B 702 and C 704, in accordance with the method disclosed herein.

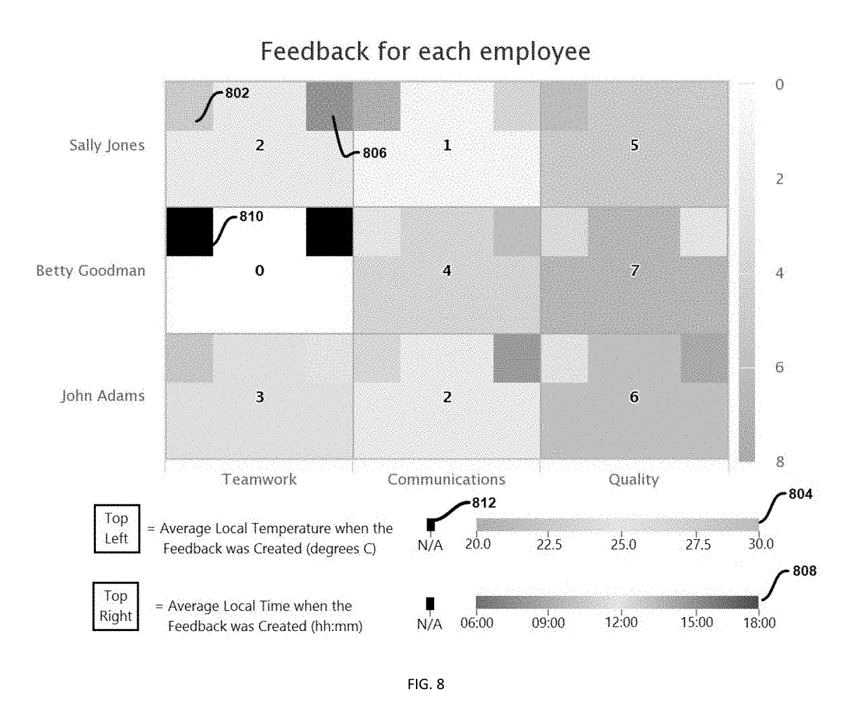

FIG. 8 illustrates the same information as the 2D heatmap displayed in FIG. 6, except that overlays with unique regions have been used instead of overlays with graphical icons for variables B and C. In accordance with the invented method, the fill color of the region overlay in the upper left hand corner of each cell 802 has been varied according to value for variable B for that cell, as governed by the color scale 804 for values of variable B. The fill color of the region overlay in the upper right hand corner of each cell 806 has been varied according to value for variable C for that cell, as governed by the color scale 808 for values of variable C. In this example, black is displayed as the fill color for a region 810 when no value is applicable for a variable in accordance with the N/A value on the scale 812 for this variable.

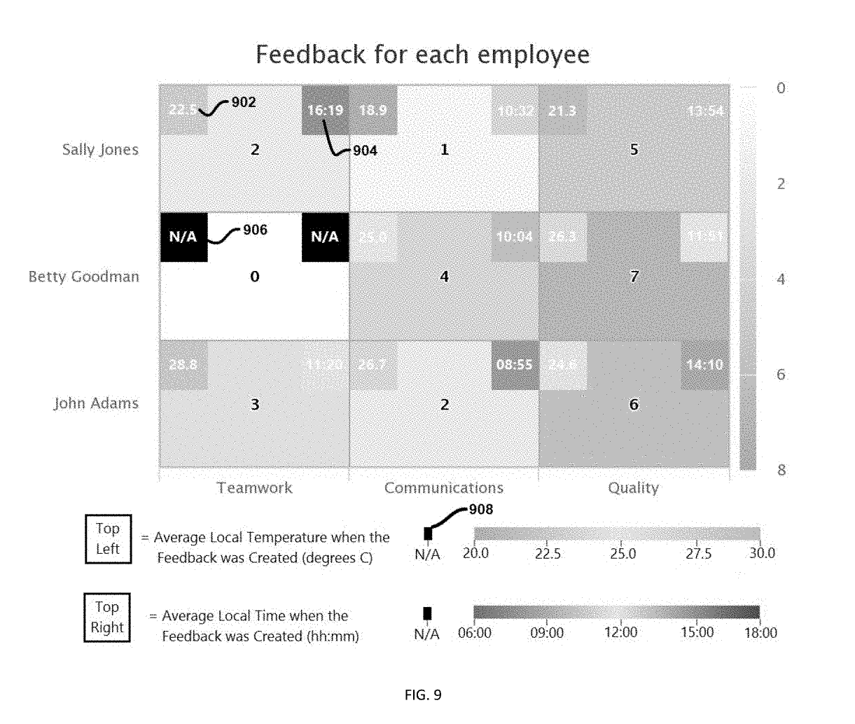

FIG. 9 illustrates the same information as the 2D heatmap displayed in FIG. 8, with the addition of numerical values displayed in each overlay region for variables B 902 and C 904 in accordance with the method disclosed herein. In this example, N/A is displayed as the numeric 906 when no value is applicable for a variable in accordance with the N/A value on the scale 908 for this variable.

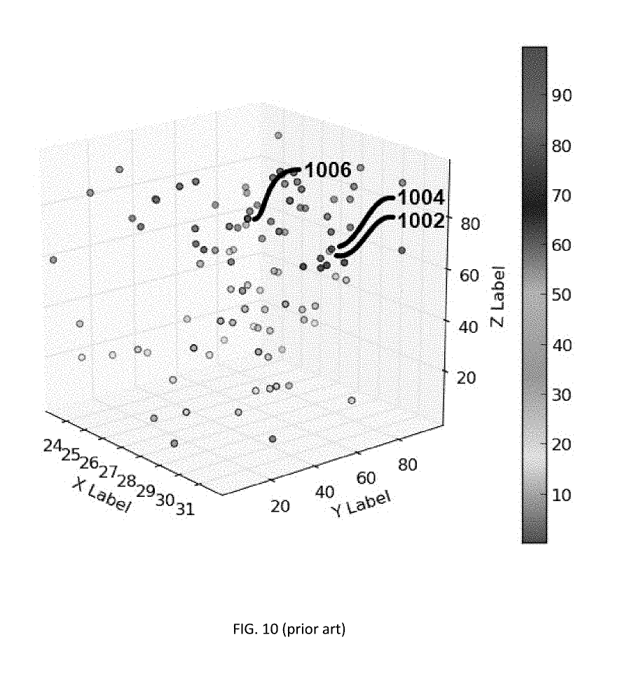

FIG. 10 illustrates an example of a prior art three-dimensional (3D) heatmap. 3D heatmaps plot data from four variables onto three axes. When printed and viewed on a flat sheet of paper, or viewed statically on a two-dimensional computing display, data for some values may be partially or fully obscured by other data. In this 3D heatmap, a data point plotted “further back” in the chart 1002 is partially obscured by a data point plotted “toward the front” of the chart 1004. Also, due to their distance from the x-axis and y-axis scales, it is difficult for the chart viewer to determine the X and Y values for values plotted higher on the Z axis 1006. This heatmap was generated with a commercial graphics package.

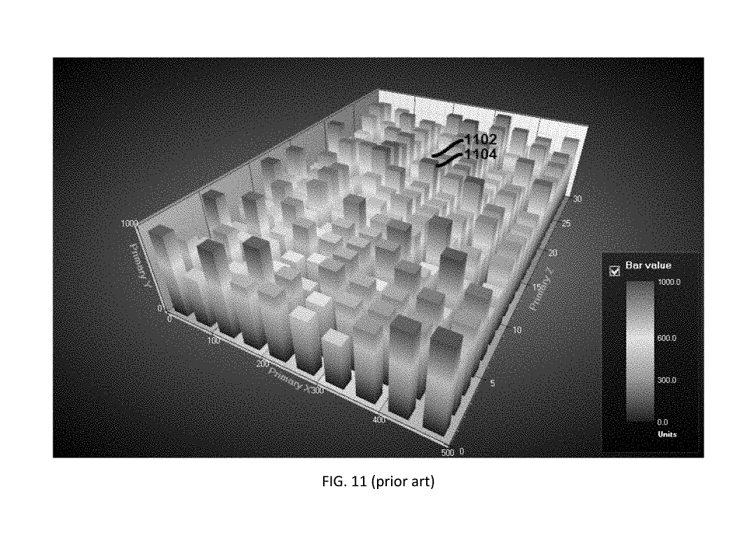

FIG. 11 illustrates another example of a prior art three-dimensional (3D) heatmap. In this 3D heatmap, data values displayed “further back” may also be partially or fully obscured by values displayed “toward the front” of the chart. For example, a bar with lower value for the y-axis 1102 (note that the y-axis is the vertical axis on this graph) plotted “further back” on the z-axis and x-axis, is partially obscured by a bar with a higher value 1104 plotted “further forward” on the z-axis and x-axis. This heatmap was generated with a commercial graphics package.

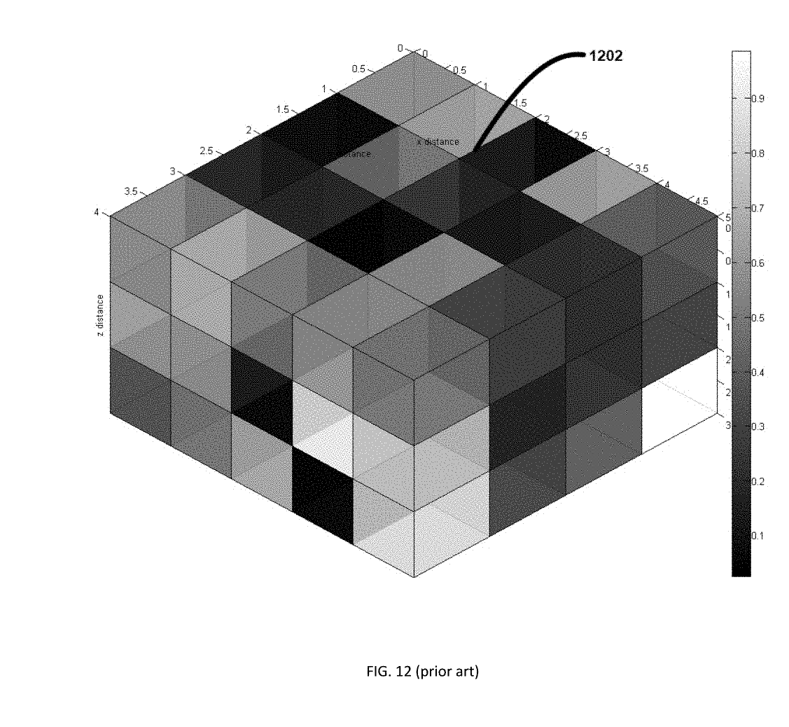

FIG. 12 illustrates another example of a prior art three-dimensional (3D) heatmap. In this 3D heatmap, some data values are partially or fully obscured by other values. For example, a data value in the middle band of the z-axis toward the back of the chart 1202 is fully obscured from the chart viewer. This heatmap was generated with a commercial graphics package.

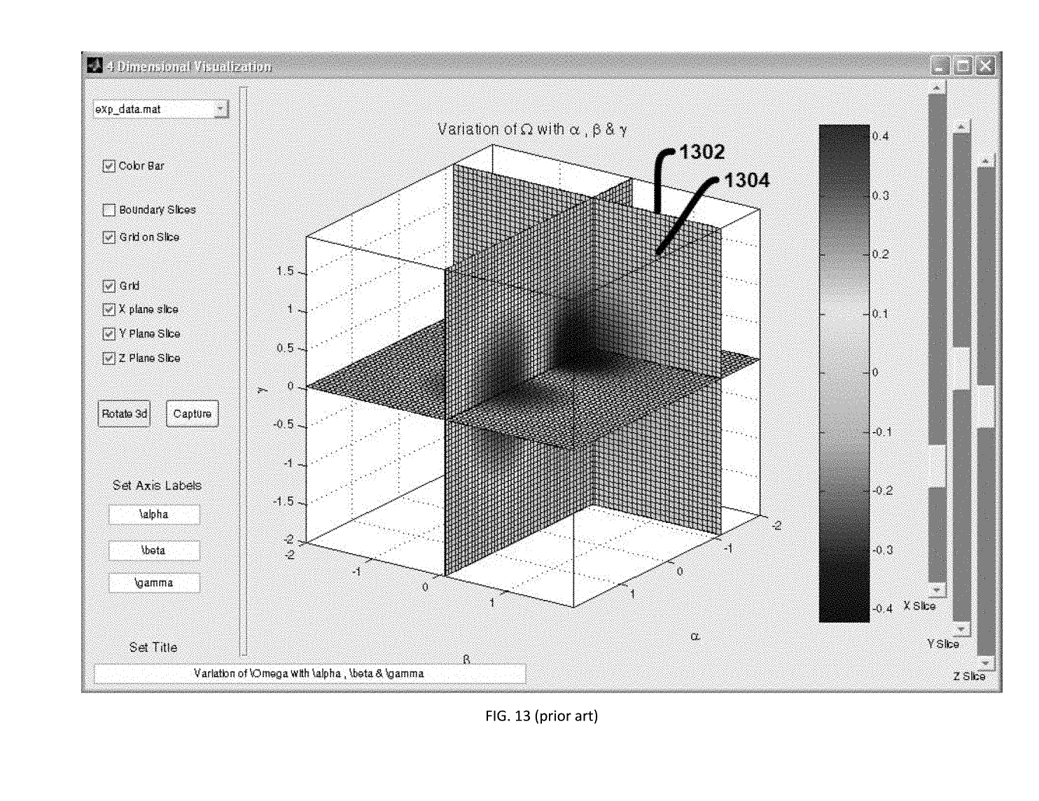

FIG. 13 illustrates an example of a prior art four-dimensional (4D) heatmap. 4D heatmaps plot data for a matrix of five variables. When printed and viewed on a flat sheet of paper, or viewed statically on a two-dimensional computing display, data for some values may be partially or fully obscured by other data. For example, in this 4D heatmap, a data point plotted “further back” and “behind the grid” 1302 in the chart is fully obscured by the grid itself 1304. This heatmap was generated with a commercial graphics package.

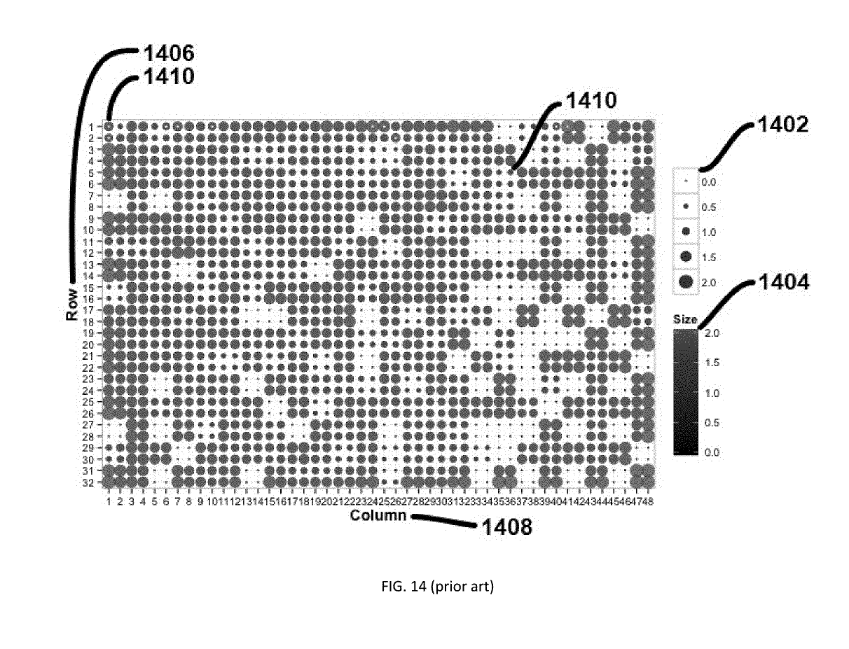

FIG. 14 illustrates a prior art bubble heatmap. A bubble heatmap can display values for two variables in each cell (bubble) and a total of four variables in a matrix. One value is indicated by the size of the bubble according to the scale on the upper right hand side of the chart 1402 and the other value is indicated by the fill of the bubble (color or shade) according to the scale on the lower right hand side of the chart 1404. The values for other two variables define a bubble's row 1406 and column 1408 location in the chart.

Small bubble sizes make it more difficult for the chart viewer to distinguish the fill color or shade for the bubble 1410.

Very small bubbles may be rendered as a “donut,” where the center “hole” is the size of the bubble and “ring” is the color or shade of the bubble. The data displayed in Row1, Column1 1412 is an example of a donut. Because the outside ring of the donut is very large, it tends to distort the chart viewer's ability to scan the chart for bubble size in a bubble heatmap. This heatmap was generated with a commercial graphics package.

We claim:

1. A computer-implemented method that applies a graphical overlay to a two-dimensional (2D) heatmap with square or rectangular said cells displayed in a row and column format along the x-axis and the y-axis to represent the value of each variable in each said cell in excess of the matrix of the three variables [X, Y, Z] represented in said 2D heatmap.

2. The method of claim 1 further comprising: one or more said variables in excess of said matrix of said three variables [X, Y, Z] represented in said 2D heatmap.

3. The method of claim 1 further comprising: said graphical overlay to each said cell consisting of one unique region or unique graphical icon in each said cell for each said variable in excess of said matrix of said three variables [X, Y, Z] represented in said 2D heatmap.

4. The method of claim 1 further comprising: said unique region can include any area within each said cell, including the border of each said cell, or the fill area of the alphanumerical value for the Z variable displayed in each said cell in said 2D heatmap.

5. The method of claim 1 further comprising: said unique region or said unique graphical icon for each said variable in said graphical overlay is identical in location within each said cell in said 2D heatmap.

6. The method of claim 1 further comprising: the fill (color or shade) of each said unique region or each said unique graphical icon is varied according to a scale that is specific to the range of values for said variable so that it represents the value for said variable in said cell, based on the x-axis and y-axis coordinates of said cell.

7. The method of claim 1 further comprising: in addition to varying said fill so that it represents said value for each said variable in each said cell, said value for each said variable in each said cell may also be displayed alphanumerically in each said unique region or each said unique graphical icon in said 2D heatmap.

8. A system comprising: one or more hardware processors; and one or more non-transitory computer-readable media coupled to one or more said hardware processors, one or more said non-transitory computer-readable media storing instructions that, when executed by one or more said hardware processors, cause one or more said hardware processors to perform operations comprising:
a. storing, and retrieving said matrix of four or more said variables, including said variables X, Y, Z,
b. generating a two-dimensional (2D) heatmap with square or rectangular cells displayed in a row and column format along the x-axis and the y-axis of said heatmap using said variables X, Y, Z,
c. generating said graphical overlay to each said cell consisting of one unique region or unique graphical icon in each said cell for each said variable in excess of said matrix of said three variables [X, Y, Z] represented in said 2D heatmap,
d. generating said graphical overlay such that said unique region or said unique graphical icon for each said variable in said graphical overlay is identical in location within each said cell in said 2D heatmap,
e. generating said graphical overlay such that the fill (color or shade) of each said unique region or each said unique graphical icon is varied according to a scale that is specific to the range of values for said variable so that it represents the value for said variable in said cell, based on the x-axis and y-axis coordinates of said cell,
f. generating said graphical overlay such that said value for each said variable in each said cell may also be displayed alphanumerically in each said unique region or each said unique graphical icon in said 2D heatmap,
whereby said values for said matrix of four or more said variables is rendered in a 2D heatmap with the graphical overlay so it can be printed and viewed on a flat sheet of paper, or displayed statically on a two-dimensional computer display, without obscuring any of the data from any of the variables.
